(19) United States
(12) Patent Application Publication
(10) Pub. No.: US 2010/0165001 A1
(43) Pub. Date: Jul. 1, 2010

(54) WHITE LIGHT BACKLIGHTS AND THE LIKE WITH EFFICIENT UTILIZATION OF COLORED LED SOURCES

(76) Inventors: Vadim N. Savvateev, St. Paul, MN (US); Rolf W. Biernath, Wyoming, MN (US); John A. Wheatley, Lake Elmo, MN (US); Michael A. Meis, Stillwater, MN (US)

Correspondence Address: 3M INNOVATIVE PROPERTIES COMPANY, PO BOX 33427, ST. PAUL, MN, 55133-3427, US

(21) Appl. No.: 12/600,970

(22) PCT Filed: May 19, 2008
(86) PCT No.: PCT/US08/64129

§ 371 Date: Nov. 19, 2009

Related U.S. Application Data
(60) Provisional application No. 60/939,083, filed on May 20, 2007.

(51) Int. Cl. G09G 5/10

(52) U.S. Cl. 345/690

(57) ABSTRACT

A backlight includes n1, n2, and n3 colored LED light sources of a first, second, and third (non-white) color respectively, and a drive circuit connected to these sources. The drive circuit is configured to drive each of the first, second, and third light sources within a specified percentage, such as 10%, of their respective maximum drive characteristics, and the numbers n1, n2, and n3 are selected so that light from the energized first, second, and third LED light sources, when combined, is substantially white. In some cases, the backlight also includes a number n4 of white LED sources, and the colored LED sources may or may not be driven within 10% of their maximum ratings. The number n4 of white sources is selected to increase the brightness of the backlight while maintaining the color gamut of the backlight output within a specified percentage, such as 10%, of a desired specification.

### FIELD

The present invention relates to extended area light sources that emit white light but that incorporate colored light sources, the outputs of which are combined to produce white light. One example of a white-light emitting extended light source is a backlight suitable for illuminating a liquid crystal display or other graphic from behind. Another example is an extended source for general illumination purposes.

### BACKGROUND

Since at least the days of Isaac Newton, it has been known that white light is composed of the spectrum of visible colors from blue through red. The corollary to this—that white light can be produced by combining different colored light beams, such as a red, green, and blue beam—has also been known, and continues to fascinate school children when they see this principle demonstrated.

This same principle is utilized in certain state-of-the-art thin panel television units. These units use arrays of individual red, green, and blue light emitting diodes (LEDs) to illuminate a liquid crystal display (LCD) panel. The red, green, and blue LEDs are arranged in a regular repeating pattern on a back surface of the device, and a strongly diffusing plate is mounted above the LEDs to provide a relatively uniform extended white source of light behind the entire area of the LCD panel. In the repeating pattern, the LEDs are clustered in groups of four closely spaced LEDs—one red, one blue, and two green. Identical clusters are then arranged in a pattern over the back surface of the device. The entire population of LEDs used in the unit thus has a ratio of red (R): green (G): blue (B) of 1:2:1.

The LEDs, diffusing plate, and other components that cooperate to provide the extended white light source behind the LCD panel are collectively referred to as a “backlight.”

Backlights can be considered to fall into one of two categories depending on where the internal light sources are positioned relative to the output area of the backlight, where the backlight “output area” corresponds to the viewable area or region of the display device. The “output area” of a backlight is sometimes referred to herein as an “output region” or “output surface” to distinguish between the region or surface itself and the area (the numerical quantity having units of square meters, square millimeters, square inches, or the like) of that region or surface.

The first category is “edge-lit.” In an edge-lit backlight, one or more light sources are disposed—from a plan-view perspective—along an outer border or periphery of the backlight construction, generally outside the area or zone corresponding to the output area. Often, the light source(s) are shielded from view by a frame or bezel that borders the output area of the backlight. The light source(s) typically emit light into a component referred to as a “light guide,” particularly in cases where a very thin profile backlight is desired, as in laptop computer displays. The light guide is a clear, solid, and relatively thin plate whose length and width dimensions are on the order of the backlight output area. The light guide uses total internal reflection (TIR) to transport or guide light from the edge-mounted lamps across the entire length or width of the light guide to the opposite edge of the backlight, and a non-uniform pattern of localized extraction structures is provided on a surface of the light guide to redirect some of this guided light out of the light guide toward the output area of the backlight. Such backlights typically also include light management films, such as a reflective material disposed behind or below the light guide, and a reflective polarizing film and prismatic BEF film(s) disposed in front of or above the light guide, to increase on-axis brightness.

The second category is “direct-lit.” In a direct-lit backlight, one or more light sources are disposed—from a plan-view perspective—substantially within the area or zone corresponding to the output area, normally in a regular array or pattern within the zone. Alternatively, one can say that the light source(s) in a direct-lit backlight are disposed directly behind the output area of the backlight. A strongly diffusing plate is typically mounted above the light sources to spread light over the output area. Again, light management films, such as a reflective polarizer film, and prismatic BEF film(s), can also be placed atop the diffuser plate for improved on-axis brightness and efficiency. In some cases, a direct-lit backlight may also include one or some light sources at the periphery of the backlight, or an edge-lit backlight may include one or some light sources directly behind the output area. In such cases, the backlight is considered “direct-lit”if most of the light originates from directly behind the output area of the backlight, and “edge-lit” if most of the light originates from the periphery of the output area of the backlight.

LCD panels, because of their method of operation, utilize only one polarization state of light, and hence for LCD applications it may be important to know the backlight's brightness and uniformity for light of the correct or useable polarization state, rather than simply the brightness and uniformity of light that may be unpolarized. In that regard, with all other factors being equal, a backlight that emits light predominantly or exclusively in the useable polarization state is more efficient in an LCD application than a backlight that emits unpolarized light. Nevertheless, backlights that emit light that is not exclusively in the useable polarization state, even to the extent of emitting randomly polarized light, are still fully useable in LCD applications, since the non-useable polarization state can be easily eliminated by an absorbing polarizer provided at the back of the LCD panel.

### BRIEF SUMMARY

Applicants have found that devices that use individual colored LED sources do not necessarily make the most effective use of those sources. Applicants have found, for example, that the relative number of all red, green, and blue (or other component color) LEDs used in a white light-emitting backlight can be tailored according to their respective maximum drive characteristics and maximum output characteristics, in such a way as to minimize or substantially reduce the total number of colored LEDs in the backlight. This can be particularly useful for edge-lit backlights, since the physical space or “real estate” that can be used to mount the LED devices is limited, and, when normalized to the output area of the backlight, actually decreases as the backlight size increases. This is because the ratio of the perimeter to the area of a rectangle or similar shape decreases linearly (1/L) with the characteristic in-plane dimension L (e.g., length, or width, or diagonal measure of the output region of the backlight, for a given aspect ratio rectangle).

Applicants have also found relationships that can optimize the design of white light backlights that utilize both colored LEDs and white light-emitting LEDs. The number of white light-emitting LEDs can be selected to be great enough to enhance or substantially maximize the brightness of the output illumination area, while maintaining a color gamut of the backlight output within a specified percentage of a desired color gamut specification.

Thus, the application discloses, inter alia, white light backlights that have an output illumination area, a plurality of colored light sources disposed to emit light into such area (e.g., via a recycling cavity, light guide, diffuser plate, or otherwise), and a drive circuit connected to the plurality of colored light sources. In some embodiments, the plurality of colored light sources have a first number n1 of first LED light sources, a second number n2 of second LED light sources, and a third number n3 of third LED light sources, the first, second, and third LED light sources (i) emitting light of a first, second, and third color respectively, the first, second, and third colors being non-white and substantially different from each other, and (ii) having first, second, and third maximum drive characteristics, respectively, with corresponding first, second, and third maximum output characteristics. The circuit is configured to drive the first LED light sources within, for example, 10% of the first maximum drive characteristic, and drive the second LED light sources within 10% of the second maximum drive characteristic, and drive the third LED light sources within 10% of the third maximum drive characteristic. Further, the numbers n1, n2, and n3 are selected so that light from the energized first, second, and third LED light sources, when combined, is substantially white. In other embodiments, the plurality of colored light sources can have any suitable number of LED light sources that emit any number of colors, e.g., sources that emit light of first, second, third, and fourth colors.

The application also discloses white light backlights that have an output illumination area, a plurality of colored light sources disposed to emit light into such area, a number n4 of white LED light sources also emitting light into the output area, and a drive circuit connected to the plurality of colored light sources and to the white LED light sources. The plurality of colored light sources have a first number n1 of first LED light sources, a second number n2 of second LED light sources, and a third number n3 of third LED light sources, the first, second, and third LED light sources (i) emitting light of a first, second, and third color respectively, the first, second, and third colors being non-white and substantially different from each other, and (ii) having first, second, and third maximum drive characteristics, respectively, with corresponding first, second, and third maximum output characteristics. The number n4 of white LED light sources is selected to enhance or maximize the luminous efficiency of the output illumination area, given the numbers n1, n2, and n3 of first, second, and third LED light sources, while maintaining a color gamut of the output illumination area within a specified percentage, such as 10%, of a desired color gamut.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a schematic perspective view of a backlight;

FIGS. 2a-c depict a hypothetical relative drive strength needed to produce white light for individual LEDs, for different LED arrangements or clusters;

FIG. 3a depicts the measured color gamut in CIE 1931 x,y color coordinates for a white-emitting LED;

FIG. 3b depicts the measured color gamut in CIE 1931 x,y color coordinates for an RGGGGB LED combination; and

FIG. 4 shows a top or front view of an arrangement of colored LEDs.

### DETAILED DESCRIPTION OF THE ILLUSTRATIVE EMBODIMENTS

The combinations of colored and white light-emitting LEDs discussed herein can be used in backlights or other extended area light sources of almost unlimited design. In simplest form, the backlight may contain only the light sources mounted in a cavity that is covered with a diffusion plate to spread and combine (or “mix”) light from the individual light source into a uniform output. The backlight may also contain a back reflector to help collect backwards-propagating light for improved efficiency. If the backlight is of the edge-lit variety, it may also include a solid light guide to help transport the light laterally across the output area of the backlight. Light management films, such as reflective polarizers, prismatic Brightness Enhancement Films (BEF), turning films, diffusing films, high reflectivity specular reflectors, diffuse reflecting films, and the like can also be used. Through a combination of such backlight components and backlight geometry, the backlight is preferably constructed so that light from the various colored sources and white light-emitting sources (if any) is adequately mixed or homogenized to provide a backlight whose brightness and uniformity characteristics are suitable for the intended application.

One class of backlights that is useful and advantageous, but by no means required, in connection with the disclosed light source combinations is the class of backlights that incorporate a recycling cavity. Exemplary backlights of this type are disclosed in the following commonly assigned PCT Patent applications: “Thin Hollow Backlights With Beneficial Design Characteristics” (Attorney Docket No. 63031WO003); “Recycling Backlights With Semi-specular Components” (Attorney Docket No. 63032WO003); “Collimating Light Injectors for Edge-Lit Backlights” (Attorney Docket No. 63034WO004); and “Backlight and Display System Using Same” (Attorney Docket No. 63274WO004). At least some of the backlights described in these applications have some or all of the following design features:
a recycling optical cavity in which a large proportion of the light undergoes multiple reflections between substantially coextensive front and back reflectors before emerging from the front reflector, which is partially transmissive and partially reflective;
overall losses for light propagating in the recycling cavity are kept extraordinarily low, for example, both by providing a substantially enclosed cavity of low absorptive loss, including low loss front and back reflectors as well as side reflectors, and by keeping losses associated with the light sources very low, for example, by ensuring the cumulative emitting area of all the light sources is a small fraction of the backlight output area;
a recycling optical cavity that is hollow, i.e., the lateral transport of light within the cavity occurs predominantly in air, vacuum, or the like rather than in an optically dense medium such as acrylic or glass;
in the case of a backlight designed to emit only light in a particular (useable) polarization state, the front reflector has a high enough reflectivity for such useable light to support lateral transport or spreading, and for light ray angle randomization to achieve acceptable spatial uniformity of the backlight output, but a high enough transmission into the appropriate application-useable angles to ensure application brightness of the backlight is acceptable;
the recycling optical cavity contains a component or components that provide the cavity with a balance of specular and diffuse characteristics, the component having sufficient specularity to support significant lateral light transport or mixing within the cavity, but also having sufficient diffusivity to substantially homogenize the angular distribution of steady state light within the cavity, even when injecting light into the cavity only over a narrow range of angles (and further, in the case of a backlight designed to emit only light in a particular (useable) polarization state, recycling within the cavity preferably includes a degree of randomization of reflected light polarization relative to the incident light polarization state, which allows a mechanism by which non-useable polarized light is converted into useable polarized light);
the front reflector of the recycling cavity has a reflectivity that generally increases with angle of incidence, and a transmission that generally decreases with angle of incidence, where the reflectivity and transmission are for unpolarized visible light and for any plane of incidence, and/or for light of a useable polarization state incident in a plane for which oblique light of the useable polarization state is p-polarized (and further, the front reflector has a high value of hemispheric reflectivity and while also having a sufficiently high transmission of application-useable light);
light injection optics that partially collimate or confine light initially injected into the recycling cavity to propagation directions close to a transverse plane (the transverse plane being parallel to the output area of the backlight), e.g., an injection beam having an average flux deviation angle from the transverse plane in a range from 0 to 40 degrees, or 0 to 30 degrees, or 0 to 15 degrees.

Regardless of the type of backlight chosen, we now turn our attention to issues that are raised by the use of individual colored LED sources to provide an extended area white light output, other than the challenge of physically homogenizing or mixing the light. In FIG. 1, we see a schematic perspective view of a crude backlight containing three colored LED sources 12a, 12b, 12c, such as red-, green-, and blue-emitting LEDs respectively. Drive circuits 18a, 18b, 18c couple to and energize the respective light sources as shown. The drive circuits in this embodiment and in other disclosed embodiments can be of conventional design. A diffuser plate 14 intercepts and homogenizes light emitted by the three sources to provide a backlight output area 16 that emits white light.

Depending on the degree to which a particular shade or hue of “white” is desired or required in the intended application, one quickly realizes that the degree of “white” achieved at the output area is highly dependent on the relative strength (for light emitting diodes, usually expressed as an electrical current “I” or an electrical power “P=I*V”, where V is the voltage drop across the given diode) with which the circuits 18a, 18b, 18c drive their respective sources. For today's commercially available colored LEDs, green-emitting LEDs tend to contribute less to the creation of a white light spectrum than their red and blue counterparts. This is reflected by the fact that if a red, green, and blue LED of similar design are obtained from a manufacturer, and they are each driven or powered at their maximum recommended drive characteristic (typically, a maximum operating current at a given temperature) and their outputs combined, the result is light of a distinctly purple hue due to an excess of red and blue light, or a deficiency of green light.

As mentioned above, some existing LED-powered devices use twice the number of green LEDs as red or blue LEDs, grouped together in clusters of four. However, applicants have found that even with that arrangement, powering all four LEDs at their maximum recommended drive characteristic will still produce a purple hue of light. As a result, since the green LEDs are already providing their maximum light output, power for the red and blue LEDs (whether electrical power, or electrical current, or total emitted optical power, or otherwise) must be reduced substantially below their maximum operating points to achieve a balance to produce “white.”

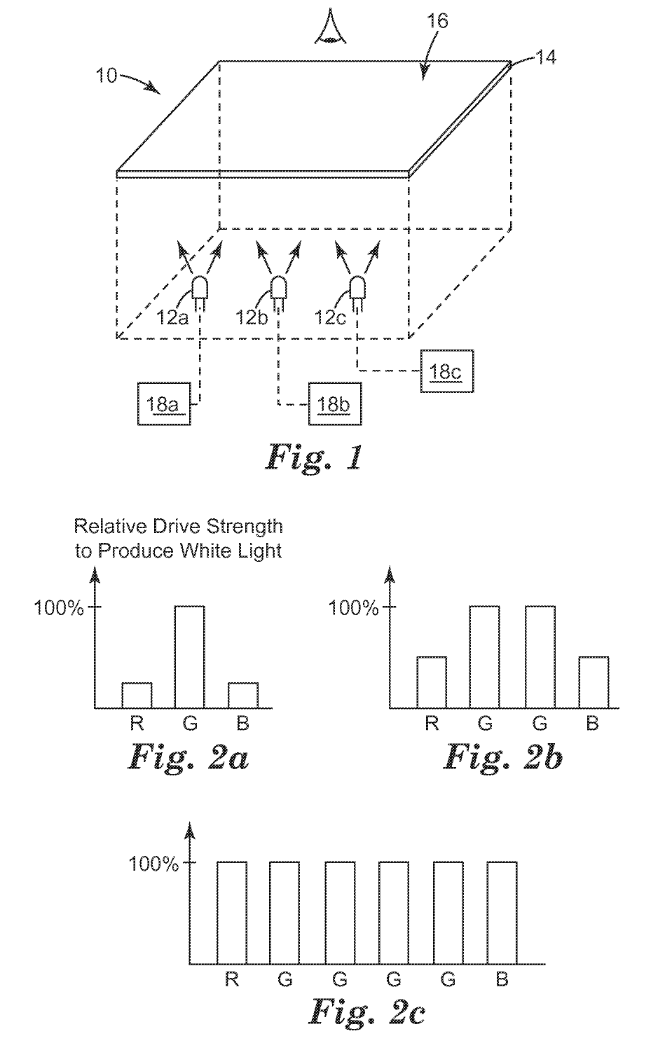

Although this situation is considered commercially acceptable by LED/LCD TV manufacturers, applicants have identified an opportunity for improvement, i.e., better utilization of the colored LED sources. FIGS. 2a-c are provided to illustrate the opportunity identified by applicants. Note that these figures do not plot measured data, and are greatly simplified for purposes of illustration. The figures plot the relative drive strength necessary to produce “white” light, where relative drive strength is given for a particular LED as a percentage of a maximum recommended drive characteristic for that LED, where the drive characteristic may be, for example, electrical power P, electrical current I, or total emitted optical power. The figures thus do not assume that the drive characteristics for the different colored LEDs are the same.

FIG. 2a is for a group of three LEDs, one red, one green, one blue, or “RGB.” The red and blue LEDs contribute more to the creation of white light spectrum than the green LEDs, such that their drive strength must be reduced to similar levels to produce white light when mixed with the green LED output. In the figure, the reduced levels are each 25%.

Adding another green LED to the group of FIG. 2a results in a group of four LEDs, one red, two green, one blue, or RGGB. The drive strengths for this new group are depicted in FIG. 2b. Since there is twice as much green light as in the RGB group, the red and blue LEDs can be driven at twice their respective levels from FIG. 2a. Even in this arrangement, however, the red and blue LEDs are being driven substantially below their respective maximum recommended drive characteristics.

We now pose the question: what combination of different colored (R, G, B) LEDs are necessary such that all of the LEDs can be driven at or near their respective maximum recommended drive characteristic, but whereby their combined optical outputs still provide the desired “white” light output? In the case at hand, the answer is that two more green LEDs must be added, yielding RGGGGB as shown in FIG. 2c. With this combination, all of the colored LED sources contributing to the backlight output are driven at or near their respective maximum drive characteristic. In practice, deviations from 100% may be needed to tune the output to the desired white point, e.g., a particular correlated color temperature. In LCD TV backlight applications, for example, a CCT of 6500 K, otherwise known as D65, may be desired. Adjustments to the drive strength may also be needed to account for color variability among LED sources that are all nominally the same color. Adjustments to drive strength may also be needed to account for color drift as the individual LEDs experience temperature fluctuations, or as the LEDs age. Thus, it is desirable for all LEDs of a given color, whether R, G, B, or other, to have an average drive strength within a specified percentage of their maximum drive characteristic. The specified percentage may be, for example, 25%, 20%, 15%, 10%, or 5% (i.e., average relative drive strength of 75%, 80%, 85%, 90%, or 95% respectively), and preferably the sources are not driven significantly beyond not their respective maximum drive characteristics.

From another perspective, the total number of colored LEDs can if desired be reduced to a minimum number that is a function of the total number of LEDs of a particular color being used in the backlight. This condition is most meaningful when there are relatively large numbers of LEDs for each particular color, e.g., at least 5 or at least 10. Suppose, for example, there are n1 total red LEDs, and n2 total green LEDs, and n3 total blue LEDs providing light to the backlight. Suppose further the red LEDs are operated at an average relative drive strength of 95%. If there are 10 red LEDs (n1=10), then 95% of 10 is 9.5, and every one of the 10 red LEDs is needed. However, if there are 100 red LEDs (n1=100), then 95% of 100 is 95, and thus the number of red LEDs could be reduced to 95 (operated at an average relative drive strength of 100%) while producing the same amount of red light as before. The same analysis can be applied to any other group of colored LEDs in the backlight. In general, this condition can be expressed as the drive circuit for the different LEDs being configured to drive the red LED light sources at an average of x % of the red LED maximum drive characteristic, and drive the green LED light sources at an average of y % of the green LED maximum drive characteristic, and drive the blue LED light sources at an average of z % of the blue LED maximum drive characteristic, and n1*(1−x %)<1, and n2*(1−y %)<1, and n3*(1−z %)<1.

Following the above methodology can help to substantially reduce the number of colored LEDs needed in a particular application, and thus the cost of manufacture. For example, although the RGGGGB group of FIG. 2c contains more colored LEDs than the RGGB group of FIG. 2b or the RGB group of FIG. 2a, the RGGGGB group is emitting two times more white light than the RGGB group, and four times more white light than the RGB group. In order to emit the same amount of white light as the six LEDs of the RGGGGB group, eight LEDs (two groups) would be required for the RGGB group, and 12 LEDs (four groups) would be required for the RGB group.

The reduced number of colored LEDs can be used beneficially in any backlight, but is of particular benefit in edge-lit backlights where the “real estate” or space available for mounting LEDs is limited to the edges of the backlight cavity. For example, for a 40 inch diagonal 16:9 aspect ratio TV or backlight provides 88.5 centimeters of lineal distance if only one long edge (top or bottom) is available for light sources, or 99.6 cm if both short edges (sides) are available, or 177.1 cm if both long edges are available. In some cases the methodology described above may allow the total number of LED sources to fit along only one long edge, e.g., in a desirable bottom-only configuration.

In some cases, an edge-lit backlight or similar device requiring an extended row of many LED sources may have sufficient real estate “width” or “depth” to accommodate more than one row in parallel. For example, the edge of a backlight cavity may accommodate the following two rows of clustered RGGGGB LEDs:

RGGGGB RGGGGB RGGGGB RGGGGB

RGGGGB RGGGGB RGGGGB RGGGGB.

The rows need not be identical to each other, as in the following arrangement:

Rb Rb Rb Rb

GGGG GGGG GGGG GGGG.

Other color configurations are also possible. For example, when combining white LEDs with colored LEDs as described herein, a new and different combination of red, green, and white can also be defined. White LEDs are typically fabricated using a blue LED die, and include a yellow phosphor that when stimulated by some of the blue light, will emit a yellow light such that the combination of blue and yellow will appear white. In fabricating these white LEDs, the color temperature of the LED can be varied from “cool white,” which appears blue-ish, to “warm white,” which appears more amber or golden. By selecting the white LEDs to be of the “cool white” variety, it is possible to define a combination of red, green, and white LEDs where the blue light required in a typical R-G-G-B combination is actually contributed by the excess blue from the cool white LEDs. Thus, in some embodiments, no blue LEDs are required to produce white light.

Light sources useful in the present disclosure could include red, green, blue, (or combinations of other colored light sources that produce white light) and white. In some embodiments, when a lower brightness image is desired, only colored light sources can be activated, while at higher brightness levels, the RGB light sources remain at a plateau maximum brightness and white light sources are used to reach the required brightness. This driving arrangement has the benefit of increased power efficiency while maintaining high color gamut across a wide range of luminance levels. This system could further incorporate dynamic brightness control wherein the content of each image is analyzed for required brightness and the backlight is dynamically adjusted to that brightness. In zoned backlight systems, the image of each zone could be analyzed for required brightness, and the backlight for that zone could be adjusted to the required brightness as described herein.

### Example 1

In this example, red, green, and royal blue Luxeon III Lambertian emitting devices sold by Philips Lumileds Lighting Company were characterized at a slug or heat sink temperature of 50 degrees C. The red LED had a maximum current rating of 1.4 A, and the green and blue LEDs each had a maximum current rating of 700 mA. Their respective color, flux, and cost characteristics are as follows:

| Color | Red LED | Green LED | Blue LED |
|---|---|---|---|
| X | 0.35 | 0.03 | 0.12 |
| Y | 0.15 | 0.11 | 0.02 |
| Z | 0.00 | 0.02 | 0.62 |
| x | 0.70 | 0.19 | 0.15 |
| y | 0.30 | 0.70 | 0.03 |
| TLF (Lm) | 105.83 | 77.37 | 12.89 |
| Cost (US $) | 3.10 | 2.20 | 2.20 |

In the table, TLF refers to total luminous flux, a quantity measured in Lumens. We now consider two color units that are each balanced to a color point CCT=6500 K, i.e., (x,y)=(0.314, 0.326). In both cases we balanced the color to within ΔE<0.0025, where ΔE is a color difference defined as the square root of (Δx²+Δy²), where x and y are coordinates in the CIE 1931 color coordinate space. The two color units (or LED groups) compared were one RGGB unit, and one RGGGGB unit:

| | Configuration | | | | | | | |
|---|---|---|---|---|---|---|---|---|
| | RGGB | | | | RGGGGB | | | |
| | Color or unit | | | | | | | |
| | R | G | B | Unit | R | G | B | Unit |
| Atten % at D65 | 50 | 98 | 50 | — | 100 | 98 | 100 | — |
| Lumens/color | 51 | 154 | 7 | 212 | 102 | 308 | 13 | 423 |
| US$/color | 3.1 | 4.4 | 2.2 | 9.7 | 3.1 | 8.8 | 2.2 | 14.1 |
| No. of LEDs | — | — | — | 4 | — | — | — | 6 |
| Lumens/US$ | — | — | — | 22 | — | — | — | 30 |

The RGGGGB unit, in which every LED is driven at or close to its rated power, provides a lower cost white light. Using the metric of Lumens/US$, the RGGGGB unit offers about 35% more light per dollar invested into component cost than an RGGB unit.

We now compare the same two LED units for a typical 40 inch (diagonal) 16:9 LCD-TV, requiring a total luminous flux of 6500 lumens. The RGGB unit requires 124 LEDs (31 units or clusters), 272 watts, and costs $300.70. The RGGGGB unit requires 96 LEDs (16 units or clusters), 281 watts, and costs $225.60. The latter unit allows significantly decreased LED count, cost, and real estate (whether on the backlight edge, or backplane). With an LED package size of 0.9 cm, the RGGB unit (110.6 cm required) allows only for the “top and bottom” mounting design for the light engines. The RGGGGB unit, in contrast, only requires 86.4 cm, thus allowing a choice of “side lit” or even a “bottom only” mounting design. Savings may also be realized in reduced circuitry, wiring, mechanical support, and assembly labor associated with the reduced LED package count.

### Example 2

In this example, red, green, and royal blue Lambertian emitting devices sold by OSRAM were characterized at a slug or heat sink temperature of 50 degrees C. These were surface mount (SMT) devices, also known as Advanced Power TOPLED devices. Reference is made to OSRAM documents Jun. 19, 2006 (Blue, Green—ThinGaN), Mar. 28, 2006 (Red-Enhanced ThinFilm LED), and Aug. 30, 2006 (White—ThinGaN). Their respective color, flux, and cost characteristics are as follows:

| Color | Red LED | Green LED | Blue LED |
|---|---|---|---|
| X | 0.0366 | 0.0052 | 0.0133 |
| Y | 0.0159 | 0.025 | 0.007 |
| Z | 6E−06 | 0.0019 | 0.0866 |
| x | 0.6972 | 0.1621 | 0.1243 |
| y | 0.3027 | 0.7793 | 0.0652 |
| TLF (Lm) | 10.852 | 17.058 | 4.7578 |
| Cost (US $) | 0.21 | 0.39 | 0.39 |

We again consider two color units that are each balanced to a color point CCT=6500 K, i.e., (x,y)=(0.314, 0.326). In both cases we again balanced the color to within ΔE<0.0025 of the D65 color point. The two color units (or LED groups) compared were one RGGB unit, and one RRRGGGGBB unit:

| | Configuration | | | | | | | |
|---|---|---|---|---|---|---|---|---|
| | RGGB | | | | RRRGGGGBB | | | |
| | Color or unit | | | | | | | |
| | R | 2G | B | Unit | 3R | 4G | 2B | Unit |
| Atten % at D65 | 100 | 68 | 68 | — | 100 | 100 | 100 | — |
| Lumens/color | 10.88 | 23.27 | 3.24 | 37.0 | 32.65 | 68.43 | 9.54 | 111.0 |
| US$/color | 0.21 | 0.78 | 0.39 | 1.38 | 0.63 | 1.56 | 0.78 | 2.97 |
| No. of LEDs | — | — | — | 4 | — | — | — | 9 |
| Lumens/US$ | — | — | — | 27 | — | — | — | 37 |

One again sees that the RRRGGGGBB unit, in which every LED is driven at or close to its rated power, provides a lower cost white light, offering about 35% more light per dollar invested into component cost than the RGGB unit.

We now compare the same two LED units for a typical 15 inch (diagonal) 16:9 LCD-TV, requiring a total luminous flux of 900 lumens. The RGGB unit requires 96 LEDs (24 units or clusters), 30 watts, and costs $33.00. The RRRGGGGBB unit requires 72 LEDs (8 units or clusters), 30 watts, and costs $24.00. The latter unit allows significantly decreased LED count, cost, and real estate (whether on the backlight edge, or backplane). With an LED package size of 3.5 mm, the RGGB unit (33.6 cm required) allows only for the “top and bottom” mounting design. The RRRGGGGBB unit, in contrast, only requires 25.2 cm, thus allowing a choice of “side lit” or even a “bottom only” mounting design. Savings may also be realized in reduced circuitry, wiring, mechanical support, and assembly labor associated with the reduced LED package count.

### Addition of White Light Emitting LEDs to Colored LED Systems

White light emitting LEDs, in which a blue or UV-emitting LED die is covered with a phosphor to provide a small area source that emits white light, are known. Commonly, the LED emits blue light and the phosphor emits yellow light, and some of the blue light is transmitted through the phosphor layer. The blue light combined with the yellow light then produce white. Such white-emitting LEDs can be incorporated into lighting systems that also contain colored LED sources.

Applicants have found that commercially available white-emitting LEDs tend to be more efficient (Lumens per watt of electrical power expended) at producing white light than combinations of colored LEDs, but that the colored LEDs provide a higher color gamut and are currently lower cost.

This is demonstrated by the following comparison. A white-emitting LED, namely an Xlamp manufactured by Cree, Inc. in a 7090 package, was obtained. It was compared to the colored LED combination of RGGGGB, composed of 1 red, 1 blue, and 4 green Luxeon III LEDs operated at 50 degrees C. The white-emitting LED cost $2.42, and had a smallest transverse dimension of 0.7 cm. The colored LEDs cost $14.10 (total), and had a smallest transverse dimension of 0.9 cm (each). The following measurements were made at a rated DC current of 350 mA: the white LED exhibited a CCT of 6500, had a total luminous flux of 51.5 lumens, and produced 1.20 watts of Joule heat; the colored LED combination exhibited a CCT of 6500, had a total luminous flux of 423 lumens, and produced 17.6 watts of heat.

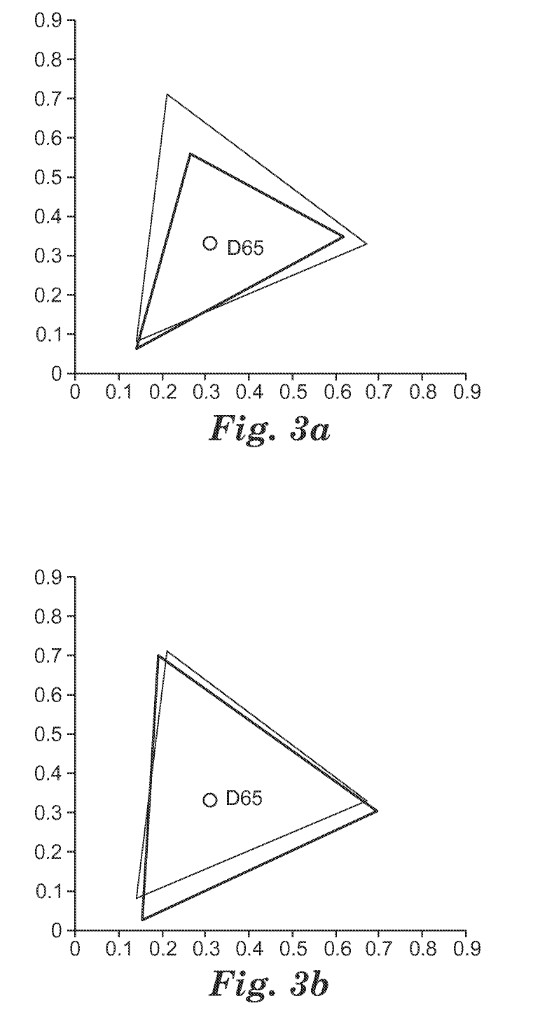

The color gamut of these two systems was determined with the use of an LCD panel having a color filter plane, and measuring red/green/blue color intensities and color components separately. The results are shown in the color-space plots of FIGS. 3a (for the white-emitting LED) and 3b (for the RGGGGB LED combination). Both figures plot the measured color gamut (thick-lined triangles) for the respective systems using CIE 1931 x,y color coordinates. Both figures also show the D65 color point, as well as the NTSC 1953 color gamut (thin-lined triangle). One can see that the color gamut provided by the colored LED combination is substantially larger in area than that of the white-emitting LED. The color gamut of each system was calculated as a percentage of the NTSC 1953 standard, with the result of 64% for the white-emitting LED; and 112% for the colored LED combination. This same comparison (with the NTSC 1953 standard) was repeated after converting the color values to CIE 1976 color coordinates (u′, v′), with the result of 77% for the white-emitting LED; and 148% for the colored LED combination.

These two systems were also evaluated for the case of a light engine needed to produce 5500 lumens, with the following result:

| | White-emitting LED | RGGGGB LEDs |
|---|---|---|
| Units | 107 | 13 |
| Cost of LEDs (US $) | 258.94 | 183.30 |
| Joule heat (W) | 128.40 | 228.80 |
| % gamut* | 77 | 148 |
| TLF (Lm) | 5510.5 | 5499 |
| Real estate (cm) | 74.9 | 70.2 |

The % gamut listed is measured using the (u′, v′) color coordinates against the NTSC 1953 standard. One can see that the white-emitting LED produces far less Joule heat than the colored LEDs for about the same total luminous flux. On the other hand, the colored LEDs provide a much larger color gamut than the white-emitting LED. On this basis, we propose that white-emitting LEDs may be added to a colored-LED system in a controlled amount to balance system brightness gains with system color gamut losses. The color gamut may be expressed as a percentage of a desired color gamut standard, such as the NTSC 1953 standard, or another desired standard depending on the intended application of the system. For example, other color gamut standards include: Adobe RGB (1998); Apple RGB; Best RGB; Beta RGB; Bruce RGB; CIE RGB; ColorMatch RGB; Don RGB 4; ECI RGB; Ekta Space PS5; PAL/SEC AM RGB; ProPhoto RGB; SMPTE-C RGB; sRGB; and Wide Gamut RGB. Furthermore, the color gamut may be measured in (x,y) color coordinates or (u′, v′) color coordinates.

We now demonstrate the effect of adding white-emitting LEDs to a colored LED system to achieve a desired balance. We begin with 13 groups or clusters of RGGGGB Luxeon III LEDs as described above, operated at a slug temperature of 50 degrees C. This produces 5500 lumens of white light, a suitable light engine for a 40 inch (diagonal) 16:9 LCD-TV backlight. We then proceed to remove the colored LED clusters, one-by-one, and replace them with groups of white-emitting LEDs in such a quantity to preserve the overall luminous flux of 5500 lumens. The results are shown in the following table:

| No. of RGGGGB | No. of white- | | |
|---|---|---|---|
| clusters | emitting LEDs | % gamut* | Joule heat (W) |
| 13 | 0 | 148.5 | 228.8 |
| 12 | 9 | 136.8 | 222 |
| 11 | 17 | 128.7 | 214 |
| 10 | 25 | 122.0 | 206 |
| 9 | 33 | 116.3 | 198 |
| 8 | 42 | 110.8 | 191.2 |
| 7 | 50 | 106.1 | 183.2 |
| 6 | 58 | 101.8 | 175.2 |
| 5 | 66 | 97.7 | 167.2 |
| 4 | 74 | 93.6 | 159.2 |
| 3 | 83 | 89.5 | 152.4 |
| 2 | 91 | 85.5 | 144.4 |
| 1 | 99 | 81.4 | 136.4 |
| 0 | 107 | 77.2 | 128.4 |

As before, the % gamut was calculated against the NTSC 1953 standard, in (u′, v′) space. One can see that as the colored LED clusters are replaced with white-emitting LEDs, the color gamut declines. The amount of heat generated also declines, but since the total luminous flux is being held constant, this means the luminous efficiency (in lumens/watt) increases. Thus, for a given power consumption, the brightness of the system increases. Alternatively, for a given system brightness, the total power consumption and heat generation decreases, which reduces the system's thermal management requirements.

If one specifies that the color gamut is within 10% of the target color gamut, i.e., in this case the NTSC 1953 standard in (u′, v′) coordinates, then at least the embodiments having 4, 5, 6, or 7 colored LED clusters (or 74, 66, 58, or 50 white-emitting LEDs) would be acceptable. With a more stringent 5% of target requirement, the embodiments having 5 or 6 colored LED clusters (66 or 58 white-emitting LEDs) remain acceptable. Depending on tolerances or requirements of the intended application, other percentages or degrees of accuracy can also be used.

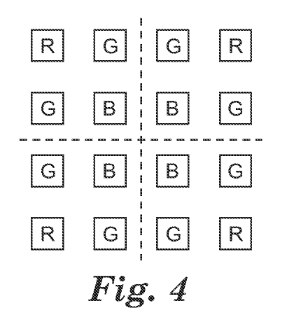

Both in cases where white-emitting LEDs are added to colored LED systems, and where only colored LEDs are present in the backlight system, it can be advantageous for the pattern or arrangement of LEDs to exhibit symmetry. In the case of a direct-lit backlight, a cluster of LEDs that is disposed adjacent a highly reflective side surface of the cavity can produce a virtual image of itself in such surface, potentially giving rise to colored artifacts in the backlight output area. Ensuring that the cluster possesses mirror symmetry about a first and second local plane (e.g., vertical and horizontal, or parallel to a first cavity side surface and parallel to a second cavity side surface) can help reduce such annoyances. Reference is made to the plan view layout of a colored LED cluster shown in FIG. 4. In the case of a linear arrangement of LEDs such as would be used in an edge-lit backlight, the LEDs can also be arranged in clusters or repeat units that exhibit mirror symmetry. An example of such a cluster that combines both colored LEDs and white-emitting LEDs is GRGBGRWWWWWWRGBGRG.

In the foregoing discussion, it should be understood that any color combinations (not limited to three different colors) that combine to provide white light can be substituted for “red,” “green,” and “blue.” For example, cyan sources and yellow sources can be combined to produce white light. The addition of these colors can also provide a higher Color Rendering Index (CRI), thereby also providing a more realistic representation of objects illuminated with the light source.

Also, as previously discussed, proper selection of the white LED sources can allow blue LED sources to be eliminated from some of the described embodiments without reducing color quality.

Unless otherwise indicated, references to “backlights” are also intended to apply to other extended area lighting devices that provide nominally uniform illumination in their intended application. Such other devices may provide either polarized or unpolarized outputs. Examples include light boxes, signs, channel letters, and general illumination devices designed for indoor (e.g., home or office) or outdoor use, sometimes referred to as “luminaires.” Note also that edge-lit devices can be configured to emit light out of both opposed major surfaces—i.e., both out of the “front reflector” and “back reflector” referred to above—in which case both the front and back reflectors are partially transmissive. Such a device can illuminate two independent LCD panels or other graphic members placed on opposite sides of the backlight. In that case the front and back reflectors may be of the same or similar construction.

The term “LED” refers to a diode that emits light, whether visible, ultraviolet, or infrared. It includes incoherent encased or encapsulated semiconductor devices marketed as “LEDs,” whether of the conventional or super radiant variety. If the LED emits non-visible light such as ultraviolet light, and in some cases where it emits visible light, it is packaged to include a phosphor (or it may illuminate a remotely disposed phosphor) to convert short wavelength light to longer wavelength visible light, in some cases yielding a device that emits white light. An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies. An LED may also include a cup-shaped reflector or other reflective substrate, encapsulating material formed into a simple dome-shaped lens or any other known shape or structure, extractor(s), and other packaging elements, which elements may be used to produce a forward-emitting, side-emitting, or other desired light output distribution.

Unless otherwise indicated, references to LEDs are also intended to apply to other sources capable of emitting bright light, whether colored or white, and whether polarized or unpolarized, in a small emitting area. Examples include semiconductor laser devices and sources that utilize solid state laser pumping.

The embodiments described herein can also include a light sensor and feedback system to detect and control one or both of the brightness and color of light from the light sources. For example, a sensor can be located near individual light sources or clusters of sources to monitor output and provide feedback to control, maintain, or adjust a white point or color temperature. It may be beneficial to locate one or more sensors along an edge or within the cavity to sample the mixed light. In some instances it may be beneficial to provide a sensor to detect ambient light outside the display in the viewing environment, for example, the room that the display is in. Control logic can be used to appropriately adjust the output of the light sources based on ambient viewing conditions. Any suitable sensor or sensors can be used, e.g., light-to-frequency or light-to-voltage sensors (available from Texas Advanced Optoelectronic Solutions, Plano, Tex.). Additionally, thermal sensors can be used to monitor and control the output of light sources. Any of these techniques can be used to adjust light output based on operating conditions and compensation for component aging over time. Further, sensors can be used for dynamic contrast, vertical scanning or horizontal zones, or field sequential systems to supply feedback signals to the control system.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Various modifications and alterations of this disclosure will be apparent to those skilled in the art without departing from the scope and spirit of this disclosure, and it should be understood that this disclosure is not limited to the illustrative embodiments set forth herein. All U.S. patents, patent application publications, unpublished patent applications, and other patent and non-patent documents referred to herein are incorporated by reference in their entireties, except to the extent any subject matter therein directly contradicts the foregoing disclosure.

What is claimed is:

1. A white light backlight having an output illumination area, comprising:
a plurality of colored light sources disposed to emit light into the output illumination area; and
a drive circuit connected to the plurality of colored light sources;
wherein the plurality of colored light sources have a first number n1 of first LED light sources, a second number n2 of second LED light sources, and a third number n3 of third LED light sources, the first, second, and third LED light sources (i) emitting light of a first, second, and third color respectively, the first, second, and third colors being non-white and substantially different from each other, and (ii) having first, second, and third maximum drive characteristics, respectively, with corresponding first, second, and third maximum output characteristics;
wherein the circuit is configured to drive the first LED light sources within 10% of the first maximum drive characteristic, and drive the second LED light sources within 10% of the second maximum drive characteristic, and drive the third LED light sources within 10% of the third maximum drive characteristic; and
wherein n1, n2, and n3 are selected so that light from the energized first, second, and third LED light sources, when combined, is substantially white.

2. The backlight of claim 1, wherein the backlight includes a cavity behind the output illumination area, and the plurality of colored light sources emit light into the cavity.

3. The backlight of claim 1, wherein the circuit is configured to drive the first LED light sources at an average of x % of the first maximum drive characteristic, and drive the second LED light sources at an average of y % of the second maximum drive characteristic, and drive the third LED light sources at an average of z % of the third maximum drive characteristic, and n1*(1−%)<1, and n2*(1−y %)<1, and n3*(1−z %)<1.

4. The backlight of claim 1, wherein the first, second, and third maximum drive characteristics are first, second, and third maximum drive currents respectively at first, second, and third operating temperatures respectively.

5. The backlight of claim 1, wherein the first color is red, the second color is green, and the third color is blue.

6. The backlight of claim 4, wherein n1=n3, and n2=4*n1.

7. The backlight of claim 1, wherein the first, second, and third LED light sources are disposed proximate a periphery of the output illumination area to provide an edge-lit backlight.

8. The backlight of claim 1, wherein the first, second, and third LED light sources are disposed directly behind the output illumination area to provide a direct-lit backlight.

9. The backlight of claim 1, wherein the first, second, and third LED light sources are arranged in clusters, each such cluster exhibiting mirror symmetry about a first local plane.

10. The backlight of claim 9, wherein each cluster also exhibits mirror symmetry about a second local plane orthogonal to the first local plane.

11. The backlight of claim 1, further comprising one or more white LED light sources that emit light into the output illumination area.

12. The backlight of claim 11, wherein the light source exhibits a color gamut that is within 10% of a desired color gamut.

13. The backlight of claim 12, wherein the light source exhibits a color gamut that is within 5% of the desired color gamut.

14. The backlight of claim 13, wherein the desired color gamut is the NTSC 1953 gamut measured in (u′, v′) coordinates.

15. A white light backlight having an output illumination area, comprising:
a plurality of colored light sources disposed to emit light into the output illumination area, the plurality of colored light sources having a first number n1 of first LED light sources, a second number n2 of second LED light sources, and a third number n3 of third LED light sources, the first, second, and third LED light sources (i) emitting light of a first, second, and third color respectively, the first, second, and third colors being non-white and substantially different from each other, and (ii) having first, second, and third maximum drive characteristics, respectively, with corresponding first, second, and third maximum output characteristics;
a number n4 of white LED light sources also emitting light into the output illumination area;
a drive circuit connected to the plurality of colored light sources and to the white LED light sources;
wherein the number n4 is selected to enhance the luminous efficiency of the output illumination area, while maintaining a color gamut of the output illumination area within 10% of a desired color gamut.

16. The backlight of claim 15, wherein the backlight includes a cavity behind the output illumination area, and the plurality of colored light sources and the number n4 of white LED light sources emit light into the cavity.

17. The backlight of claim 15, wherein the color gamut is measured in (u′, v′) color coordinates, and the desired color gamut is the NTSC 1953 gamut.

18. The backlight of claim 15, wherein the number n4 maintains a color gamut of the output illumination area within 5% of the desired color gamut.

19. The backlight of claim 15, wherein the circuit is configured to drive the first LED light sources within 10% of the first maximum drive characteristic, and drive the second LED light sources within 10% of the second maximum drive characteristic, and drive the third LED light sources within 10% of the third maximum drive characteristic, and wherein n1, n2, and n3 are selected so that light from the energized first, second, and third LED light sources, when combined, is substantially white.
